(19) United States
(12) Patent Application Publication
(10) Pub. No.: US 2016/0046299 A1
(43) Pub. Date: Feb. 18, 2016

(54) REMOTE SECONDARY CONTROL POINT FOR VEHICLE ACCESSORIES

(71) Applicant: Andrew Fung, Winter Garden, FL (US)

(72) Inventor: Andrew Fung, Winter Garden, FL (US)

(21) Appl. No.: 14/697,448

(22) Filed: Apr. 27, 2015

Related U.S. Application Data
(60) Provisional application No. 61/984,279, filed on Apr. 25, 2014.

(51) Int. Cl. B60W 50/02

(52) U.S. Cl. CPC B60W 50/0205; B60W 2050/021

(57) ABSTRACT

A remote secondary control point for vehicle accessories is disclosed. This invention illuminates the brake (or other) lights for a period of time to verify their operation by means of a switch at the rear of the vehicle. This has the added benefit of using the existing engine compartment door switch so there is almost no operational overhead.

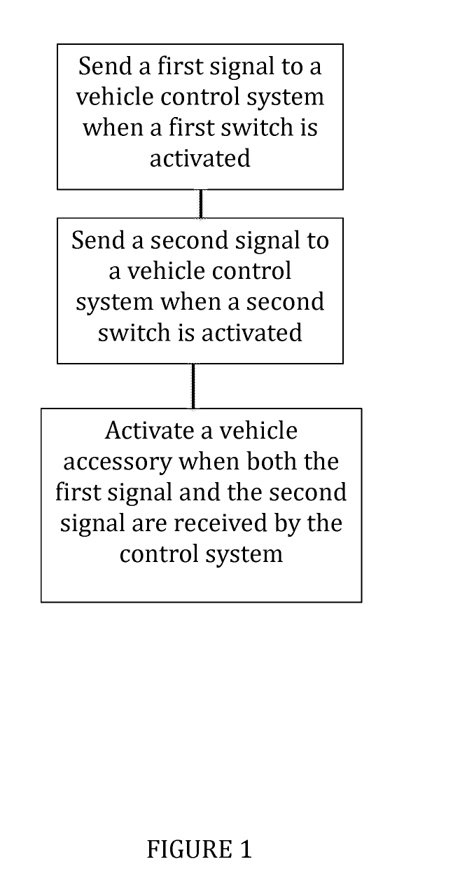

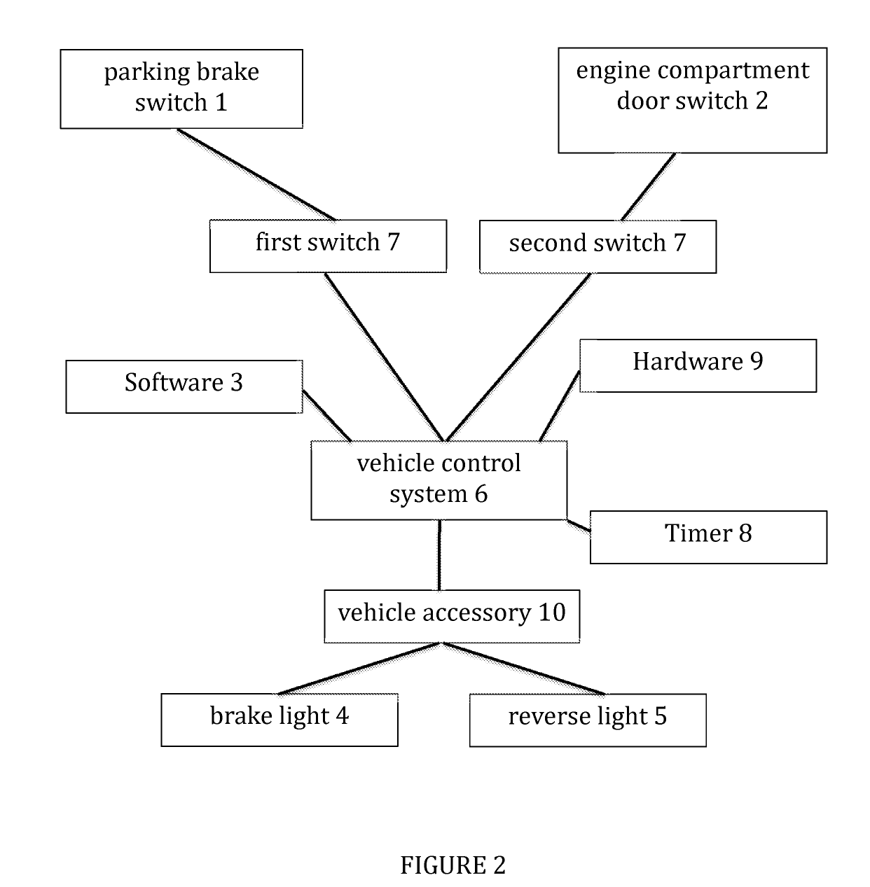

### BACKGROUND OF THE INVENTION

Problem Solved: Commercial vehicles must undergo pre-trip inspections on a daily basis. Inspecting some vehicle accessories is a two person job and cannot be performed by an individual. For example, brake lights cannot be seen by the operator when applying the brake. Inspecting reverse lights adds the risk of unintended vehicle movement.

A vehicle's operator may be alone when performing a pre-trip inspection, especially when on a trip.

This invention illuminates the brake (or other) lights for a period of time to verify their operation by means of a switch at the rear of the vehicle. This has the added benefit of using the existing engine compartment door switch so there is almost no operational overhead.

### DETAILED DESCRIPTION OF THE INVENTION

As stated above, commercial vehicles must undergo pre-trip inspections on a daily basis. Inspecting some vehicle accessories is a two person job and cannot be performed by an individual. For example, brake lights cannot be seen by the operator when applying the brake. Inspecting reverse lights adds the risk of unintended vehicle movement. The invention claimed here solves this problem.

By adding remote controls and/or conditionally retasking existing controls, accessories can be tested by an individual when in direct view. In a motor coach application, the condition is created when the park brake is applied and the engine compartment door is opened. This has the effect of turning the brake and reverse lights on for a period of time to allow for direct observation.

The claimed invention differs from what currently exists. There is no other invention to permit an individual to actually inspect, or otherwise confirm operation of, accessories that are normally out of view.

This invention is an improvement on what currently exists. There is no other invention to permit an individual to actually inspect, or otherwise confirm operation of, accessories that are normally out of view.

Mandated and safety equipment can be overlooked if it cannot be readily inspected, or if the equipment's operation cannot be readily confirmed by an operator acting alone, without help.

This invention illuminates the brake (or other) lights for a period of time to verify their operation by means of a switch at the rear of the vehicle. This has the added benefit of using the existing engine compartment door switch so there is almost no operational overhead.

The Version of the Invention Discussed here Includes:

1. 1. Park brake pressure switch 2. Rear engine compartment door switch 3. Software 4. Brake lights 5. Reverse lights

Relationship between the Components

When the (3) software embedded within the vehicle electrical system senses the park brake is applied via the (1) park brake pressure switch and the engine compartment door is open via the (2) rear engine compartment door switch it activates a 10 second timer that “appears” to the electrical system to be a service brake application. The brake and reverse lights return to normal operation after 10 seconds or when the door is closed, whichever occurs first. This allows for adequate time to confirm the operation status but returns the lamps to normal function so they operate as otherwise intended.

How the Invention Works:

Existing inputs, switches, are combinatoria ly input to set a software timer/flag that is logically OR'd with the normal function of accessories such as the stop and reverse lights. The use of a timer allows the accessories to return to normal function so they work as otherwise intended, to indicate the operation status of their respective systems. The systems do not rely on the operator to return them to normal operation so someone not familiar with this invention will not be confused by what might appear to be malfunction.

Create paths in the ladder logic that parallel the service brake pressure switch in the brake light rung and the reverse switch in the reverse light rung. These parallel paths contain a “lamp test timer”.

The lamp test timer is a one shot timer enabled (made TRUE) by the park brake pressure switch AND the rear engine door compartment switch. When the AND of these two conditions is TRUE, the timer is initiated. The timer is cleared when it times out after 10 seconds or if the AND condition becomes FALSE.

How to Make the Invention:

This invention can be implemented in software or hardware. If a software implementation is not practical, the logical functions can be implemented using diode and relay logic and timers can be used to perform the automatic function restore.

Inputs to indicate conditional status are necessary but the specific switches are optional. It is necessary to indicate the vehicle is at a standstill and the park brake switch serves this purpose but optionally, the transmission park indicator could also be used. If there is no rear engine compartment door switch, another switch, either within the compartment or on the body could be optionally used. It is necessary to provide a means to initiate the test cycle. The tinier is an option and could be omitted if another means to momentarily engage the test cycle is provided.

These elements could be used anywhere a device's control is not within reach or within sight to provide an alternate, conditional means of activation.

How to Use the Invention:

At any time during vehicle operation, but most typically during the pre-trip inspection required of commercial vehicle operators, a driver can inspect the operation status of all lights on the vehicle and other accessories and the condition and levels of critical fluids such as engine oil. Immediately after opening the engine compartment door for access to the engine, the operator can, remotely and from outside the driver compartment, observe the brake, reverse and other lights to determine their operational status without operating the controls located at the driver's station.

Additionally: This invention can be used to incorporate other conditional device activations for the purpose of routine inspection or troubleshooting.

1. A vehicle inspection system, comprising:
a first switch for providing a first signal when the first switch is activated;
a second switch for providing a second signal when the second switch is activated;
a vehicle control system having an inspection component electrically coupled to the first and second switches to receive the first and second signals, respectively, such that the inspection component activates a vehicle accessory when both the first switch and the second switch are activated.

2. The vehicle inspection system of claim 1 wherein the first switch includes a parking brake switch configured to activate when the parking brake is applied.

3. The vehicle inspection system of claim 1 wherein the first switch includes a transmission parking switch configured to activate when a vehicle transmission is actuated to a parked position.

4. The vehicle inspection system of claim 1 wherein the second switch includes an engine compartment door switch configured to activate when the engine compartment door is opened.

5. The vehicle inspection system of claim 1 wherein the vehicle accessory is at least one of a rear brake light, a parking brake light, and a reverse light.

6. The vehicle inspection system of claim 1 wherein the vehicle accessory returns to normal operation when at least one of the first and second switches are deactivated.

7. The vehicle inspection system of claim 1, further comprising a timer electrically coupled to the vehicle control system that is initiated when the first and second switches are activated.

8. The vehicle inspection system of claim 7 wherein the vehicle accessory returns to normal operation after a period of time after being activated by the inspection component.

9. The vehicle inspection system of claim 8 wherein the period of time is about 10 seconds.

10. The vehicle inspection system of claim 8 wherein the timer is cleared when at least one of the first and second switches are deactivated.

11. The vehicle inspection system of claim 1, further comprising hardware features including a diode and relay logic and timers configured to restore the vehicle accessory to normal operation after being activated.

12. A method for inspecting a vehicle accessory, comprising:
sending a first signal to a vehicle control system when a first switch is activated;
sending a second signal to a vehicle control system when a second switch is activated; and
activating a vehicle accessory when both the first signal and the second signal are received by the vehicle control system.

13. The method of claim 12 wherein sending a first signal to a vehicle control system when a first switch is activated comprises a parking brake switch configured to activate when a vehicle parking brake is applied.

14. The method of claim 12 wherein sending a first signal to a vehicle control system when a first switch is activated comprises a transmission parking switch configured to activate when a vehicle transmission is actuated to a parked position.

15. The method of claim 12 wherein sending a second signal to a vehicle control system when a second switch is activated comprises an engine door compartment switch configured to activate when a vehicle door is opened.

16. The method of claim 12, further comprising returning the vehicle accessory to normal operation when at least one of the first and second switches are deactivated.

17. The method of claim 12, further comprising initiating a timer when at least one of the first and second switches are activated.

18. The method of claim 17, further comprising returning the vehicle accessory to normal operation after the timer reaches a period of time.

19. The method of claim 18, further comprising clearing the timer after the vehicle accessory returns to normal operation.

20. A vehicle inspection system, comprising:
a first means for providing a first signal during a first vehicle operation;
a second means for providing a second signal during a second vehicle operation; and
a third means for receiving the first and second signals and activating a vehicle accessory when the first and second second signals are received, wherein the third means returns the vehicle accessory to a normal operation when at least one of the following occurs:
the first signal is interrupted, the second signal is interrupted, and a period of time passes.
